(19) United States
(12) Patent Application Publication
(10) Pub. No.: US 2010/0107067 A1
(43) Pub. Date: Apr. 29, 2010

(54) INPUT ON TOUCH BASED USER INTERFACES

(75) Inventor: Matti Vaisanen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 12/258,930

(22) Filed: Oct. 27, 2008

(51) Int. Cl. G06F 3/01

(52) U.S. Cl. 715/702

(57) ABSTRACT

A user interface for use with a device having a display and a controller, the controller being configured to receive touch input representing a slide-in gesture and in response thereto switch input mode, wherein the input mode is one of DIRECT, in which mode touch input is interpreted to be direct actions, or HOVER, in which touch input is interpreted to be hover actions.

### BACKGROUND

1. Field

The present application relates to a user interface, a device and a method for improved input, and in particular to a user interface, a device and a method for offering a wider range of input options in touch user interfaces.

2. Brief Description of Related Developments

Contemporary small display devices with touch user interfaces have fewer user input controls than traditional Windows Icon Menu Pointer (WIMP) interfaces, but they still need to offer a similar set of responses to user actions i.e. command and control possibilities.

A traditional WIMP (windows icons menus pointer) device may offer a mouse pointer, a left and right mouse button, a scroll wheel, keyboard scroll keys, and keyboard modifiers for mouse-clicks (e.g. control-left-mouse). A touch device relies entirely on touch on the screen with one or two fingers to send commands to the system, even where the underlying touch system is similar to the WIMP system and requires similar control information.

This problem becomes especially apparent when the user is trying to find out information about an object being displayed. In Graphical User Interfaces (GUI) using WIMPs this is commonly achieved by so called mouse-over events. These are events that are triggered when the cursor is placed above an object. The most common action taken for the event is to display some information regarding the object or offer a menu of options.

Simply placing a finger or a stylus over an object on a touch based user interface (UI) is ambiguous as it is unclear whether the user is tapping or hovering (as the corresponding action to mouse-over is sometimes referred to as) over the object.

One solution offered has been to allocate a hover function or mouse-over event to a single tap and to allocate a select function (equivalent to a mouse down or click event) to a double tap. This has the advantage in that the user has to tap twice to take execute a command or an action.

Another solution is to use special hardware for the touch display capable of sensing a varying pressure and assign low pressure to mean hover and high pressure to mean select. This has the obvious disadvantage in that it requires special hardware.

Another solution requiring special hardware is to have a dedicated button indicating whether the touch is to be interpreted as a hovering action or a tapping action. If the key is pressed it is a hovering action and if not it is a tapping action or vice versa. This would require an additional key and most likely a two hand operation as it might otherwise be difficult to reach the special key.

Thus there is need for an improved user interface for touch input where a tapping and a hovering action can easily be differentiated.

### SUMMARY

On this background, it would be advantageous to provide a user interface, a device, a computer readable medium and a method that overcomes or at least reduces the drawbacks indicated above by providing a user interface, a device, a computer readable medium and a method according to the claims.

A touch input gesture or interaction that starts outside a display and is continued inside the display, hereafter referred to as a slide-in gesture, is a special technical feature that offers an enriched range of input options available for a designer when designing a user interface.

Further aspects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIG. 4 is a plane front view of a device according to an embodiment,

FIG. 5 is a plane front view of a device according to an embodiment,

FIGS. 6a and b are flow charts describing a method according to an embodiment,

FIGS. 7a, b, c, d and e are screen shot views of an example according to an embodiment and

FIG. 8 is a plane front view of a device according to an embodiment of the application.

### DETAILED DESCRIPTION OF THE DRAWINGS

In the following detailed description, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

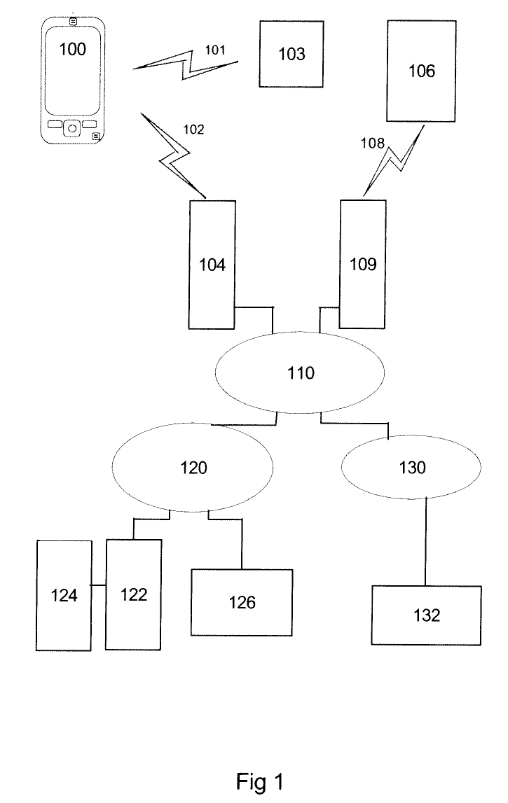

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency, RF links 102, 108 via base stations 104, 109. The mobile telecommunications network 110 may be in compliance with any commercially available mobile telecommunications standard, such as Group Speciale Mobile, GSM, Universal Mobile Telecommunications System, UMTS, Digital Advanced Mobile Phone system, D-AMPS, The code division multiple access standards CDMA and CDMA2000, Freedom Of Mobile Access, FOMA, and Time Division-Synchronous Code Division Multiple Access, TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

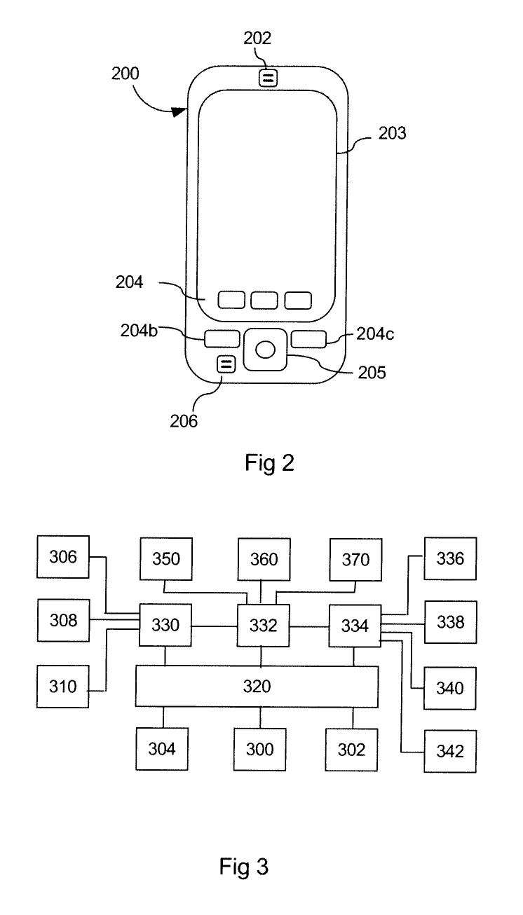

An embodiment 200 of the mobile terminal 100 is illustrated in more detail in FIG. 2. The mobile terminal 200 comprises a speaker or earphone 202, a microphone 206, a main or first display 203 being a touch display. As is commonly known a touch display may be arranged with virtual keys 204. The device is further arranged in this embodiment with a set of hardware keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM) memory, Read Only memory (ROM) memory, Electrically Erasable Programmable Read-Only Memory (EEPROM) memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the touch display 336/203, and the keys 338/204, 205 as well as various other Input/Output devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

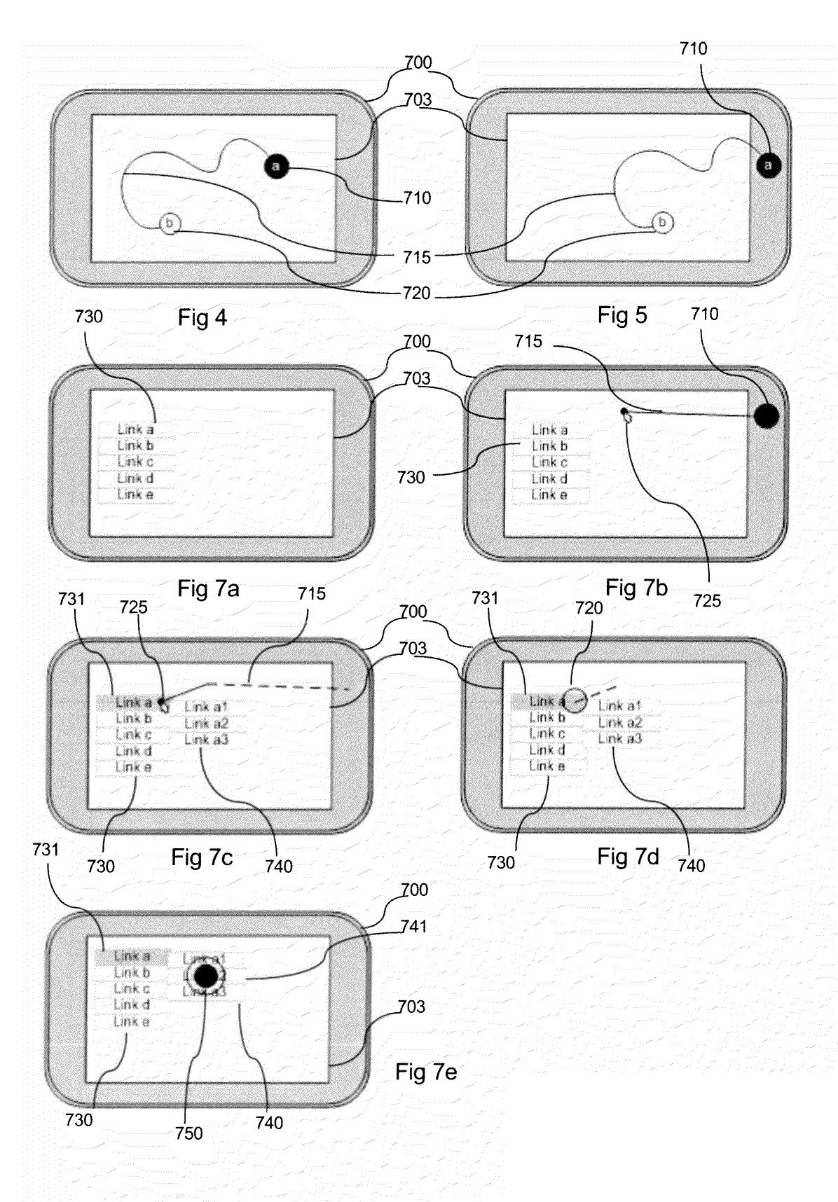

FIG. 4 shows a device 400 according to an embodiment of the teachings herein which device in this embodiment is a mobile telephone but it should be understood that this application is not limited to mobile phones, but can find use in other devices having a touch based user interface such as personal digital assistants (PDA), laptops, media players, navigational devices, game consoles, personal organizers and digital cameras. The device 400 is equipped with a touch display 403.

In this example a user has touched the display 403 by putting his finger or stylus in direct contact with the display 403, indicated by the filled dot 410. Then the user has slid his finger to another point on the display 403 indicating a path 415 to an end point indicated by an open dot 420 where the contact between the display 403 and the finger or stylus has been broken. As in contemporary device this action represents a move operation if the first point of contact 410 is on an object, which is then moved to the second point 420.

It should be noted that the direct contact is not necessary for touch displays having proximity sensing capabilities.

FIG. 5 shows a device 500 as in FIG. 4. In this example a user has made the initial contact outside the display 503 in a first contact point 510 and slid his finger in over the display 503 along a path 515 to an end point 520. A controller of the device is configured to determine that such an action is to be representing a hovering action and a mouse-over event is initiated for any object falling on the path 515. Alternatively only objects which the user stops over will receive a mouse-over event.

According to the teachings herein a controller is thus configured to determine whether an action is a direct action or a hovering action depending on an input mode. The input mode may be DIRECT or HOVER. The controller is further configured to determine that an input mode change is to be executed if a touch input gesture is started outside the display 403, 503 and continued inside, i.e. a slide-in gesture.

In one embodiment the criteria for determining such an action is if the first portion of the display to be touched is one at a very small distance form the edge of the display 503. In one embodiment the distance is set to be zero demanding that the first portion to be touched is a portion directly on the edge of the display 503. Such a gesture will from now on be referred to as a slide-in gesture.

In one embodiment a slide-in gesture can be determined as being a gesture that originates at or in the immediate vicinity of an edge of a display and immediately has a certain speed or a speed above a certain level. This allows a controller to differentiate between a gesture starting outside the display and continuing in over it from a gesture deliberately starting close to an edge of the display and continuing inside the display, such as a gesture for selecting an object located close to the edge and dragging it inside the display area. The later gesture would have an initial speed close or equal to zero.

In one embodiment the determination of the slide-in gesture depends on whether an object is covered by the path within a very short time interval. In this embodiment a user should perform the slide-in gesture so that it does not travel across any objects as it enters the display.

In one embodiment the controller is configured to determine that an input mode change is to be executed whenever a slide-in gesture is detected or received.

In one embodiment the controller is configured to execute an input mode switch to DIRECT when a touch input seizes, that is when contact between the touch display 503 and the finger/stylus is broken.

Thus two main alternatives exist. The first is that a user always switches to HOVER mode by sliding in over the display 503 and as he releases any further touch input on the touch display is in DIRECT mode. To perform further gestures in HOVER mode a further slide-in gesture has to be performed. This has the benefit that a user always knows which mode the terminal or device is currently operating in and how the controller will interpret any touch input.

The second alternative is that a user switches mode each time a slide-in gesture is performed and this mode is maintained until a user performs a new slide-in gesture upon which the mode is changed again. This has the benefit of allowing a user to make repetitive mouse-over actions without having to perform slide-in gestures.

In one embodiment the slide-in gesture is assumed to have been performed if a user initiates it outside an active area or an application area of said display. In this embodiment a user may this initiate a hover action for an object, such as a window, by sliding in over the window.

In one embodiment the application area is idle or passive at first and becomes activated upon receipt of a slide-in gesture ending up in that active area.

In this embodiment the slide-in gesture should be initiated in an area void of other objects so that no target collisions may occur.

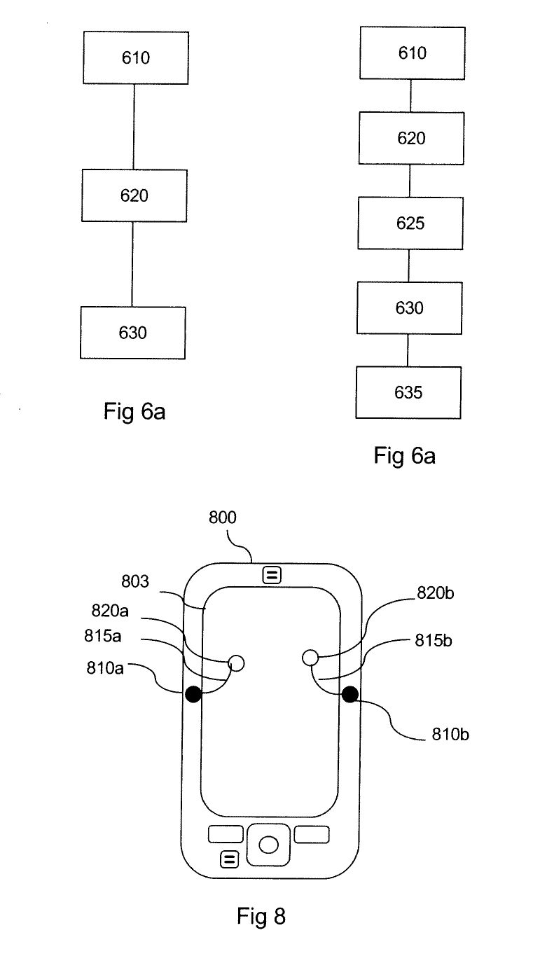

FIG. 6a shows a flowchart according to an embodiment. In an initial step 610 touch input is received. A controller determines whether a slide-in gesture has been performed in step 620 and in response thereto switches input mode 630.

FIG. 6b shows a more detailed flowchart of a method according to an embodiment. In an initial step 610 a controller receives touch input. In step 620 it is determined whether the touch input is a slide-in gesture by checking its origin in step 625. If it is outside an active area and the current position of the gesture is inside the active area it is a slide-in gesture. In step 630 the controller checks which input mode is active and switches accordingly. If it is determined in step 635 that the input mode is DIRECT the input mode is switched to HOVER.

A further problem of the prior art is how a user interface should offer a user the possibilities of actions being equivalent to right and left click actions. In a traditional WIMP system an object usually has an action associated with it that is performed when it is left-clicked upon. This action may be to select it or open it. An object usually also has a menu of other options associated with it that is displayed by right-clicking on it. For touch based systems it is difficult for a controller to differentiate between a left-click and a right-click.

By realizing that a left-click can be replaced by a mouse-over event the teachings herein can be used to differentiate between the two actions.

FIG. 7 shows an example of how this can be implemented according to the teachings herein.

FIG. 7a shows a device according to an embodiment of the teachings herein which device in this embodiment is a mobile telephone 700. It should be understood that this application is not limited to mobile phones, but can find use in other devices having a touch based user interface such as personal digital assistants (PDA), laptops, media players, navigational devices, game consoles, personal organizers and digital cameras.

The device 700 has a touch display 703 on which a list of options or objects 730 are displayed.

In FIG. 7b a finger or a stylus has made contact with the device by touching right next to the display 703 indicated by the filled dot 710 and moved his finger or stylus in over the display 703 indicated by path 715. In other words the user has performed a slide-in gesture. The open-ended path 715 indicates that contact is still maintained between the finger/stylus and the display 703.

In one embodiment a cursor 725 is displayed at the furthest point of the path 715.

In FIG. 7c the user has moved his finger to the first object 731 in the list 730. A controller of the device 700 is configured to execute an action equivalent to a mouse over event, which in this example is to display a list 740 of associated objects or options.

In one embodiment the list 730 is a menu and the list 740 is a submenu.

In one embodiment the user interface is configured to receive a command by the user sliding his finger/stylus in over an option in the option list 740 and releasing touch contact wherein the command is associated with the location where the touch input is terminated.

In one embodiment the controller is configured to maintain the displayed option list 740 being displayed as a user releases the touch contact until further input is received. Or in other words, the screen view is maintained between touch inputs.

In FIG. 7d a user has released the touch contact indicated by the open circle 720 and the controller maintains the list 740 on the display 703. This provides a user with a good overview of the available options which are no longer obscured by the stylus/finger.

In one embodiment a cursor 725 is displayed at the point where the touch input was released.

In FIG. 7e the user makes a selection of an item 741 from the options list 740 by tapping on it indicated by the full circle with a ring around it 750.

In one embodiment the initial direction of the slide-in gesture is decisive for which input mode is going to be used. For example a slide-in gesture from the right side would initiate a switch to HOVER mode. A slide-in gesture from the left would initiate a switch to DIRECT mode.

In one embodiment the display 703 is arranged so that the display is in the same level as with the front face of the device 700. In one embodiment the display is flush with the front face of said device 700. This will enable a user to more easily touch the very side or edge of the display 703.

In one embodiment the display 703 is slightly raised in relation to said front face of said device 700.

User interfaces with touch displays and few or no hardware keys are usually restricted in the input options available. The most common solution has been to provide virtual keys, but these occupy a lot of the available display area and thus limit the user interface. It is therefore an additional object of this application to provide a user interface, a method, a computer-readable medium and a device according to the claims that provide an improved user interface offering additional input options.

In one embodiment the slide-in gesture is used to input specific functions or commands other than input mode switches. A first function would be assigned to a slide-in gesture from the left, a second function would be assigned to a slide-in gesture from the top, a third function would be assigned to a slide-in gesture from the right and a fourth function would be assigned to a slide-in gesture from the bottom. It is to be understood that further divisions of the directions can be used. For example the diagonal movements or dividing the screens edges (upper left for example). It is also to be understood that it is not necessary to associate all edges with a function.

In one embodiment the function activated by the slide-in gesture is related to a currently running application.

Examples of such commands are to display the bookmarks for a web browser as a slide-in gesture is detected from the right or to display an inbox for a contact as a slide-in gesture is detected from the left.

FIG. 8 shows a device according to an embodiment of the teachings herein which device in this embodiment is a mobile telephone 800 but it should be understood that this application is not limited to mobile phones, but can find use in other devices having a touch based user interface such as personal digital assistants (PDA), laptops, media players, navigational devices, game consoles, personal organizers and digital cameras.

The device 800 has a touch display 803 and a controller (not shown). As a user performs a slide-in gesture starting on the left side of the display 803 indicated by the full circle 810a and continues the sliding gesture in over the display 803, indicated by path 815a) and releases over the display 803 indicated by the open circle 820a the controller is configured to execute a first function in response to the slide-in gesture. The first function can for example be to display the call history for a contact being displayed in a currently running phonebook application on the device 800.

If a user performs a slide-in gesture starting on the right side of the display 803 indicated by the full circle 810b and continues the sliding gesture in over the display 803, indicated by path 815b, and releases over the display 803 indicated by the open circle 820b the controller is configured to execute a second function in response to the slide-in gesture. The second gesture can for example be to display the message inbox for messages received from a contact being displayed in a currently running phonebook application on the device 800.

In one embodiment the controller is configured to execute the associated function as son as a slide-in gesture is detected and not wait until the release 820 is detected.

In one embodiment the function associated with the slide-in gesture is also associated with an object on which the slide-in gesture terminates. For example, if the device is currently displaying a list of contacts in a currently running phonebook application and the user performs a slide-in gesture from the left side ending on a specific contact: “John Smith” the controller would be configured to display the call history for John Smith.

In one embodiment the function associated with the slide-in gesture is associated with an application area in which the slide-in gesture terminates. For example if a device 800 is currently displaying a phonebook application and a browser and a user performs a slide-in gesture that terminates in the phonebook application a function associated with the phonebook application would be executed, for example displaying the call history for a contact. And if the slide-in gesture terminates in the browser application a function associated with the browser application would be executed, for example to display the bookmarks.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers or any other device designed for providing a touch based user interface.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a device will provide a user with a user interface capable of differentiating between two types of input modes in a manner that is highly intuitive and easy to learn and use for a user and which does not require any special hardware.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the disclosed embodiments believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. A user interface for use with a device having a controller and a touch display, wherein said controller is configured to:
receive touch input representing a slide-in gesture, and
execute a function associated with said slide-in gesture.

2. A user interface according to claim 1 wherein said controller is configured to determine that function is to be executed upon receipt of touch input representing a slide-in gesture which originate on or adjacent to an edge of the display.

3. A user interface according to claim 1 wherein said controller is configured to determine that said function is to be executed upon receipt of touch input which originates outside an application area.

4. A user interface according to claim 1, wherein said function is associated with an application.

5. A user interface according to claim 1, wherein said controller is configured to determine which function to execute depending on a direction of the slide-in gesture.

6. A user interface according to claim 1, wherein said controller is configured to determine which function to execute depending on which edge of said display said slide-in gesture originates.

7. A user interface according to claim 1, wherein said controller is configured to determine which function to execute depending on a release location of said slide-in gesture.

8. A user interface according to claim 1, wherein said function is associated with an application area in which said slide-in gesture terminates.

9. A user interface according to claim 1, wherein said function is associated with an object over which said slide-in gesture terminates.

10. A user interface according to claim 1 wherein said function is to switch input mode, wherein said input mode is one of DIRECT, in which mode touch input is interpreted to be direct actions, or HOVER, in which touch input is interpreted to be hover actions.

11. A user interface according to claim 3wherein said controller is configured to activate said application area in response to the received touch input and to automatically switch to input mode HOVER.

12. A user interface according to claim 10 wherein said controller is configured to switch from DIRECT mode to HOVER mode upon receipt of said received touch input.

13. A user interface according to claim 10 wherein said controller is configured to switch from HOVER mode to DIRECT mode upon release of said received touch input.

14. A user interface according to claim 10 wherein said controller is configured to display a cursor at a location corresponding to a current position or a release position of said touch input.

15. A user interface according to claim 10 wherein said controller is configured to maintain a displayed screen view upon detection of release of said received touch input.

16. A user interface according to claim 10 wherein said controller is configured to execute a command upon detection of release of said received touch input, which command is associated with a location in which said touch input is released.

17. A device incorporating and implementing or configured to implement a user interface according to claim 1.

18. A method for executing a function, said method comprising:
receiving touch input representing a slide-in gesture, and
executing a function associated with said slide-in gesture.

19. A method according to claim 18, said method further comprising determining that said function is to be executed upon receipt of touch input representing a slide-in gesture which originate on or adjacent to an edge of the display.

20. A method according to claim 18, said method further comprising determining that said function is to be executed upon receipt of touch input which originates outside an application area.

21. A method according to claim 18, wherein said function is associated with an application.

22. A method according to claim 18, wherein method further comprises determining which function to execute depending on a direction of the slide-in gesture.

23. A method according to claim 18, wherein method further comprises determining which function to execute depending on which edge of said display said slide-in gesture originates.

24. A method according to claim 18, wherein said method further comprises determining which function to execute depending on a release location of said slide-in gesture.

25. A method according to claim 24, wherein said function is associated with an application area in which said slide-in gesture terminates.

26. A method according to claim 24, wherein said function is associated with an object over which said slide-in gesture terminates.

27. A method according to claim 18 for differentiating between hovering actions and direct actions in a user interface, wherein function is to switch input mode, wherein said input mode is one of DIRECT, in which mode touch input is interpreted to be direct actions, or HOVER, in which touch input is interpreted to be hover actions.

28. A method according to claim 20, said method further comprising activating an application associated with said application area in response to the received touch input and to automatically switch to input mode HOVER.

29. A method according to claim 27, said method further comprising switching from DIRECT mode to HOVER mode upon receipt of said received touch input.

30. A method according to claim 27, said method further comprising switching from HOVER mode to DIRECT mode upon release of said received touch input.

31. A method according to claim 27, said method further comprising displaying a cursor at a location corresponding to a current position or a release position of said touch input.

32. A method according to claim 27, said method further comprising maintaining a displayed screen view upon detection of a release of said received touch input.

33. A method according to claim 27, said method further comprising executing a command upon detection of a release of said received touch input, which command is associated with a location in which said touch input is released.

34. A device incorporating and implementing or configured to implement a method according to claim 18.

35. A computer readable medium including at least computer program code for controlling a user interface, said computer readable medium comprising:
software code for receiving touch input representing a slide-in gesture, and
software code for executing a function associated with said slide-in gesture.

36. A computer readable medium according to claim 35, said computer readable medium further comprising software code for implementing said function as switching input mode, wherein said input mode is one of DIRECT, in which mode touch input is interpreted to be direct actions, or HOVER, in which touch input is interpreted to be hover actions.

37. A device incorporating and implementing or configured to implement a computer readable medium according to claim 35.

38. A user interface comprising control means for:
receiving touch input representing a slide-in gesture, and
executing a function associated with said slide-in gesture.

39. A user interface according to claim 38, wherein said function is to switch input mode, wherein said input mode is one of DIRECT, in which mode touch input is interpreted to be direct actions, or HOVER, in which touch input is interpreted to be hover actions.

40. A device incorporating and implementing or configured to implement user interface according to claim 38.
